(19) United States
(12) Patent Application Publication
(10) Pub. No.: US 2007/0157229 A1
(43) Pub. Date: Jul. 5, 2007

(54) Analytic advertising system and method of employing the same

(76) Inventor: Wayne Heathcock, Frisco, TX (US)

Correspondence Address: Wayne Heathcock, 13730 Gray Hawk Blvd., Frisco, TX, 75034, US

(21) Appl. No.: 11/649,686

(22) Filed: Jan. 4, 2007

Related U.S. Application Data
(60) Provisional application No. 60/755,973, filed on Jan. 4, 2006.

(51) Int. Cl. H04N 7/10; H04N 7/025; G06F 3/00; G06F 13/00; H04N 5/445

(52) U.S. Cl. 725/34; 725/32; 725/35; 725/46

(57) ABSTRACT

An analytic advertising system couplable to a Web-based data network and method employing the same. The analytic advertising system includes a click2metrics module configured to receive advertising information from the Web-based data network and format the advertising information into an integrated flat file. The analytic advertising system also includes an intelligent query merge module configured to merge media advertising data with the integrated flat file into a data framework. The analytic advertising system still further includes a decision analysis module configured to generate predictive analytical results from the data framework.

### CROSS REFERENCE TO RELATED APPLICATIONS

This application claims the benefit of U.S. Provisional Application No. 60/755,973, entitled “An Advanced Call Measurement System,” filed on Jan. 4, 2006, which is incorporated herein by reference.

### TECHNICAL FIELD

The present invention is directed, in general, to advertising systems and, more specifically, to an analytic advertising system and method of quantitatively discerning the value of advertising, systems of advertising, and advertising campaigns.

### BACKGROUND

The demand by advertisers in mass media for proof of marketing and advertising effectiveness has increased considerably over the last few years. This has forced media sellers and buyers to devote resources to develop infrastructure that will provide essential consumer response information to their clients. Today's businesses that advertise in television, radio, newspapers, Yellow Pages, billboards, direct mail and magazines are challenging the advertising industry to implement effective measurement tools that will confirm the direct relationship between consumers' response and mass market advertising.

The legacy approach of Nielsen-type research-based audience estimates or ratings are not efficient for today's complex advertiser as it needs to know the effectiveness of the advertising campaigns. It is widely known that the advertising community is being confronted with a market-wide call from its clients for the development of effective consumer measurement tools. In order to drive customer satisfaction, advertisers must be given proof that their advertising dollars are generating a satisfactory direct response return on investment (“ROI”), as demonstrated by tangible business intelligence (“BI”). Business intelligence for the advertiser is more than a measurement of advertising return on investment (“AROI”), or that a particular ad is generating calls. Business intelligence is providing the insightful data needed by a small business enterprise (“SBE”) so they can know:
who is the consumer;
what is the consumer's name, address, city, state, zip, and phone number;
what media type did the prospect come from;
what types of consumers respond to the media campaigns;
how far is the consumer's location from the business;
what types of consumer buys the products;
what products did they purchase and why;
what did they purchase;
how did they purchase it;
how was the call handled;
are they repeating customers;
how are customers retained;
will they buy the products again;
how are they better served:
what are the demographics.

Unfortunately, advertising, as it is deployed today, typically consists of allocating funds, designing a campaign, which can be done formally or informally, and then proceeding with the campaign. Though several attempts have been made to quantify the effectiveness of such a campaign, little quantitative evidence and few tools exist to generate a reliable quantitative measure. Often, only simple before and after tracking is employed as a measure of effectiveness while at the same time realizing that many other variables, are also in place and also changing so that even a quite aggressive attempt to assess effectiveness only provides qualitative or, at best, semi-quantitative results.

Call measurement, a process where unique phone numbers are assigned for a special product or customer, and the traffic (e.g., frequency, duration) on those numbers monitored, is one attempt to obtain useful data. Other processes, such as monitoring “clicks” at a Web site are also used.

Presently however, a deficiency exists in the tools available to measure advertising return on investment for the business or organization (the advertiser). Traditional call measurement technology only captures call data and provides it to the publisher or national advertiser via static call reports, giving the advertiser very limited data on responses to their advertisements. Often, very little information is available to the advertiser that directly relates the cost of such efforts to the benefits obtained by using them. Lack of such information results in wasted resources and missed opportunities. Therefore, what is needed is a system that captures the relevant information and additionally provides the analytical tools and metrics allowing the advertiser to close the loop for true business intelligence.

### SUMMARY

Accordingly, a need has arisen for an improved method and system for measuring the direct response return on investment of an advertising effort. The present invention provides an analytic advertising system and method for measuring the direct response return on investment of an advertising effort by capturing activity, e.g. the call traffic from a unique local or toll free number placed within the print or online advertising campaign, as well as from other sources. It then takes the captured data and maps it through a proprietary data framework structure to a decision analysis module. The system will equip customers in the advertising community with analytical tools and metrics that will provide true quantitative business intelligence.

Through the use of Monte Carlo modeling, probability density functions, Gaussian mathematical computations and influence modeling, the decision analysis module utilizes numerous levels of inputs and calculations to help businesses bring clarity to their complex advertising challenges. Finally, quantitative outputs in the form of predictive analytical results are presented in both graphical and tabular forms and customized to specific tasks. The outputs are available locally or over the Web.

Not only does the system's analytics provide key business indicators related to the financial return on investment of campaigns, they also indicate how your overall campaign effectiveness can be improved as well as predict the positive impact improvements that will be realized on revenues and profitability. Organizations will be able to gauge how effective various advertising campaign activities and marketing options are likely to be and, hence, decide how to modify and refine media campaign strategies.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of an analytic advertising system in accordance with the principles of the present invention,

FIG. 2 illustrates a diagram of an embodiment of the graphical structure of a decision analysis module constructed in accordance with the principles of the present invention,

FIGS. 3A and 3B illustrate two possible outputs from a decision analysis module constructed in accordance with the principles of the present invention,

FIGS. 4 to 13 illustrate pictorial diagrams of embodiments of Web based outputs constructed in accordance with the principles of the present invention,

FIG. 14 illustrates a diagram of an exemplary call performance report constructed in accordance with the principles of the present invention, and

FIG. 15 illustrates a diagram of an exemplary listings metrics report constructed in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to exemplary embodiments in a specific context, namely, an analytic advertising system (also referred to as “system”) and method of employing the same.

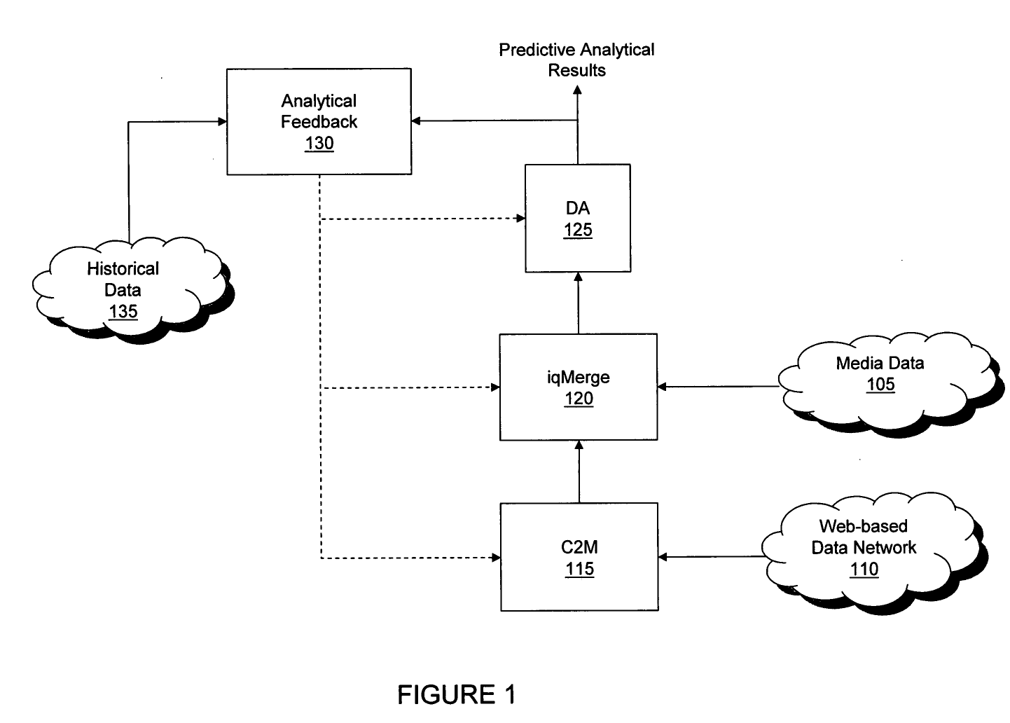

Referring initially to FIG. 1, illustrated is a block diagram of an embodiment of an analytic advertising system in accordance with the principles of the present invention. The system is configured to accept advertising information from a Web-based data network 110 into click2metrics (“C2M”) module 115 where it is processed and formatted into an integrated flat file (e.g., an XML file) for an intelligent query merge (“iqMerge”) module 120. The iqMerge module 120 merges the integrated flat file with media advertising data 105 from multiple sources to create a data framework. The output of iqMerge module 120 is the input to a decision analysis (“DA”) module 125, which generates predictive analytical results including, as an example, of advertising ROI and other relevant items. The predictive analytical results are compared with historical data 135 as time elapses and the errors noted are used to provide corrective information to modify and improve the DA module 125, the iqMerge module 120 and C2M module 115 via an analytical feedback module 130.

The Web-based data network 110 is any information that is obtained from the Internet and World Wide Web. It can be active data, for example items “clicked” by a user, or it can be passive data, for example, obtained by electronic searching. Other examples contemplated by this invention are readily available to those skilled in the art.

The C2M module 115 is a translator that goes beyond present efforts that use key word online advertising. In attempting to leverage the power of the Internet, online advertisers presently purchase key words from search engines that they believe will align their company's profile with the key words that consumers select as they use search engines to help them look for information on the Internet. The advertiser's goal is to have their Website displayed to the consumer in the highest possible sequence as the search engine returns the results of its search. The objective is for the online advertiser to drive online traffic from this consumer search activity to their Website where they can communicate their products and services directly. This technique in online advertising enables advertisers to increase revenues by designing innovative key word campaigns that utilize online search engine strategies in new ways. However, a serious shortcoming of this technique is that due to the fact that the advertiser is not communicating directly with the consumer, it can only track the following items:
impressions such as whether the advertiser's Website was displayed in response to a key word that was entered by an Internet user;
click through such as whether, using the hyperlink to the advertiser's Website that was provided by the search engine, the Internet user clicked to and went to my Website; and
click to conversion such as whether, following the search engine link to the advertiser's Website, the Internet user then made a purchase.

The C2M module 1115, alternatively, overcomes this serious deficiency in the following manner. An online advertiser would use a unique call measurement tracking number (e.g., a telephone number) along with a key word campaign. This unique call tracking number would be placed into the online advertisement in order to prompt the online consumer to call the local business that is being advertised. In this manner, the online consumer contacts the local business directly, and once the consumer dials the unique call tracking number, the system is able to gather detailed data on the caller. In this manner, by using C2M module 115, online advertisers are able to:
track prospects from online searches;
track conversion from prospects to customer;
map sales results to each key word campaign;
measure direct response metrics ROI;
compare direct response metrics key word campaigns;
determine which key words generated the most response; and
provide an input to the iqMerge framework to integrate online metrics with call tracking metrics.

The iqMerge module 120 is a business intelligence framework designed specifically to streamline data exchange between external data sources and the system's analytical and reporting engines. The iqMerge module's 120 straight-through processing model enables the customers to leverage business transactions and process them into meaningful interactive reports and data sets. With the iqMerge module 120, all portions of the advertising value chain can share and exchange data in a consistent manner.

The iqMerge module 120 accepts any form of flat file such as but not limited to ASCII, and XML based files. Additionally, the iqMerge module 120 can accept media advertising data in the form of metrics involved with people tracking, advertising metrics and referred advertisements. It is also designed to accept media advertising data from data mining engines. The media types of data that are valid inputs to iqMerge module 120 include, but are not limited to, newspapers, Yellow Pages, television, cable, Internet protocol television (“IPTV”), satellite based video and data services, pay per click, pay per call, search engines, and keyword searches.

The iqMerge module 120 uses a common set of data definitions for the advertising industry to create the data framework and may be based upon the advertising business intelligent framework (“ABIF”) standards. It fundamentally changes how publishers and larger advertisers manage their data relationships by accepting data from and passing data to different sources and repositories. The iqMerge module 120 is adapted to:
turn existing or legacy call measurement data into meaningful reports and tactical analytics;
validate data as it is collected;
create a repository of data analytics and knowledge base;
shorten the life cycle of getting up-to-date data to the sales force;
map data from other advertising initiatives such as online analytics;
consolidate data from other advertising campaigns for strategic marketing opportunities and operations;
reduce integration cost for external systems;
eliminate costly customization strategies;
turn manual reporting methods into an automated process;
increase productivity through automation by providing straight-through processing; and
streamline existing processes for e-commerce and CRM external data applications.

Today many businesses have collected volumes of data in different forms and types, and from many sources that are currently not being utilized to assist in making challenging decisions. With the DA module 125, the data and a user's specific domain knowledge is integrated into quantitative and actionable results. This enables critical insight into overall business strategies and advertising challenges. Its core features include:
providing powerful modeling techniques in a user-friendly environment;
accepting diverse inputs without forcing the user to change data;
adapting to user's way of thinking;
helping to quickly and cost-effectively answer important questions impacting a business, improving advertising agility and responsiveness; and
coupled with the iqMerge module 120, data framework, data collected from other sources can easily be integrated for modeling purposes.

The DA module 125 provides strategic processing and information to users of mass-market advertising media to help them identify the channels and associated advertising strategies that will provide the greatest direct response ROI for their advertising budget. Through the use of, without limitation, Monte Carlo modeling, decision analysis, probability density functions, and influence diagramming, the DA module 125 utilizes numerous levels of inputs and calculations to help businesses bring clarity to their complex advertising challenges with quantitative results.

The process of measuring direct response return on investment begins by capturing the call traffic from a unique local or toll free number placed within the print or online advertising campaign. This data is then mapped through the iqMerge module 120 data framework to the DA module 125. The data modeling equips customers in the advertising community with analytical tools and metrics that provide true business intelligence. This is in contrast to traditional call measurement technology which only captures call data and provides it to the publisher or national advertiser via static call reports, giving the advertiser limited data on responses to their advertisements.

The capabilities of DA module 125 include, but are not limited to:
provide advertising statistical analysis modeling;
provide call measurement and analytical reports online via a Web interface 24/7;
provide smart reporting tools that allow users to self-configure call measurement and analytical reports tailored to the way they want to run their business;
connect online advertising campaigns to the local advertisers business;
predicts the most cost effective media buys;
measures advertising effectiveness with an unlimited number of variables (ad size, position, location);
merges a wide range of data types (Web clicks, demographic data);
provide real time customized reports online via Web interface—available 24/7;
provide back office data integration business intelligence data framework;
determine which media campaigns are producing the desired results;
determine what is the sales performance in response to advertising initiatives during and after the campaign;
track revenue by media type;
determine revenue by market segment;
if advertising spending is increases, how will it effect the revenue stream;
determine what ad types are generating consumer response;
determine what are the sales trends; and
determine which markets are undeveloped.

Once key business indicators have been defined, users can monitor key performance metrics against predetermined thresholds or time periods, or run several metrics models together. By examining the status of these key business drivers, users will have better visibility of key business metrics, creating an immediate opportunity for them to take action.

Additionally, the system greatly simplifies full potential by providing visualizations with graphs, diagrams and charts that make complex analysis simple, enabling business users to optimize their media campaigns by tracking a range of key performance indicators, some of which are listed above. It provides strategic information to users of mass-market advertising media to help them identify the channels and associated advertising strategies that will provide the greatest direct response ROI for their advertising spend. With the DA module 125 analytical tool, a business intelligence model can be built around a specific business that will answer the tough questions in identifying and creating a corporate advertising strategy. Visualizations with graphs, diagrams and charts make complex analysis simple, enabling business users to optimize their media campaigns by tracking a range of key performance indicators such as:
which media campaigns are producing the desired results;
what is the sales performance in response to advertising initiatives during and after the campaign;
track revenue by media type;
determine revenue by market segment;
if advertising spending is increased, how will it effect the revenue stream;
what ad types are generating consumer response;
what are the sales trends
which markets are undeveloped.

Once key business indicators have been defined, users can monitor key performance metrics against predetermined thresholds or time periods, or run several metrics models together. By examining the status of these key business drivers, users will have better visibility of key business metrics, creating an immediate opportunity for them to take action.

Not only do these analytics provide key business indicators related to the financial ROI of campaigns, they also indicate how overall campaign effectiveness can be improved as well as predict the positive impact improvements that it will have on revenues and profitability. An organization will be able to gauge how effective various advertising campaign activities and marketing options are likely to be, and hence decide how to modify and refine media campaign strategies in a timely manner.

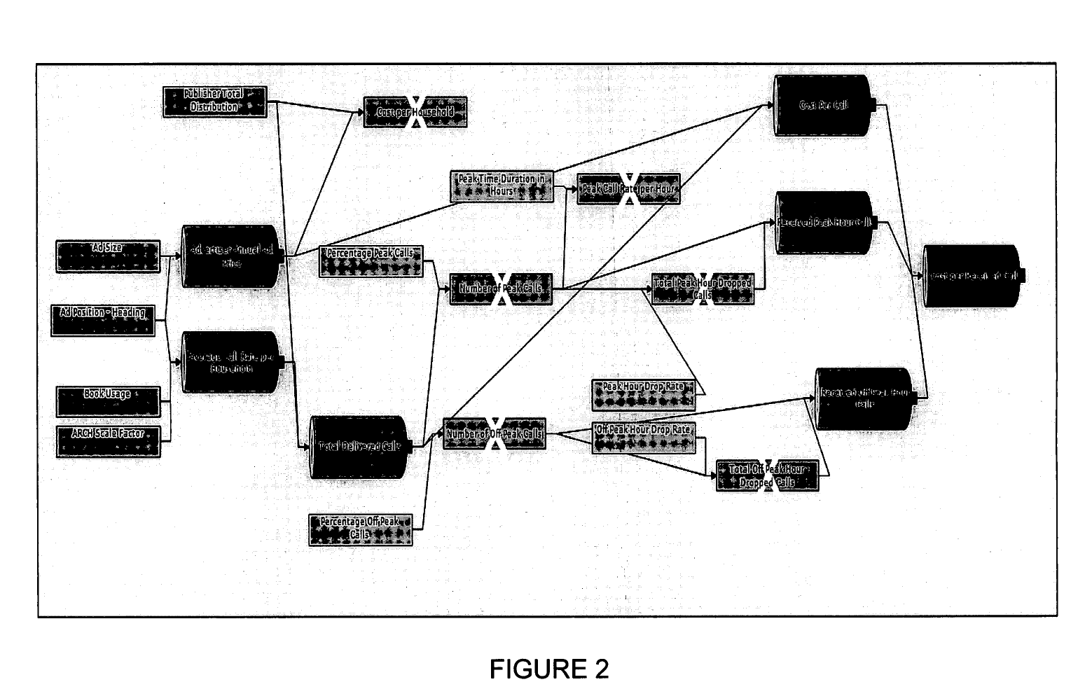

Turning now to FIG. 2, illustrated is a diagram of an embodiment of the graphical structure of a DA module including a data entry means constructed in accordance with the principles of the present invention. Note that the data entry means is a graphical process wherein the desired outputs are typically to the right of the FIGURE and inputs from the iqMerge module are on the left. For clarity, only a few elements are shown, however, there is no practical limit to the number of elements used within DA module, the number of inputs it can accept and the number of outputs. Often the total number of elements will be several hundred and even be in the thousands depending upon the complexity of the task. All are customizable to a specific business and specific application. With continuing reference to FIG. 1, the predictive analytical results exemplify the outputs of the system. These outputs are tailored for each specific task. Examples include both graphical and tabular means.

Based on the research and experience in the advertising market, the advertiser has to manage multiple variables of his advertising campaign. The aspects of an advertising campaign are as follows the advertising message, a measure of the information kept by the consumer after contact with the message, i.e., brand and advertising awareness as shown by recall studies, etc. Other aspects include the advertising influence, which is a measure of the change in objectives created by the advertising message. It is the medium's ability to structure the message in ways that make it more trustworthy, applicable and relevant, thereby making the message more persuasive. Other aspects include the advertising reaction, which refers to the amount of consumer reaction before the sale, i.e., visiting a shop, calling in response to an ad, clicking on an online ad, requesting a brochure, etc. For the Yellow Pages, it would be the number of advertisers that were contacted by potential consumers, and the total number of contacts made. Converting consumers into customers, which are the conversion of prospective customers into a purchaser of the advertised product or service, in response to the advertising media.

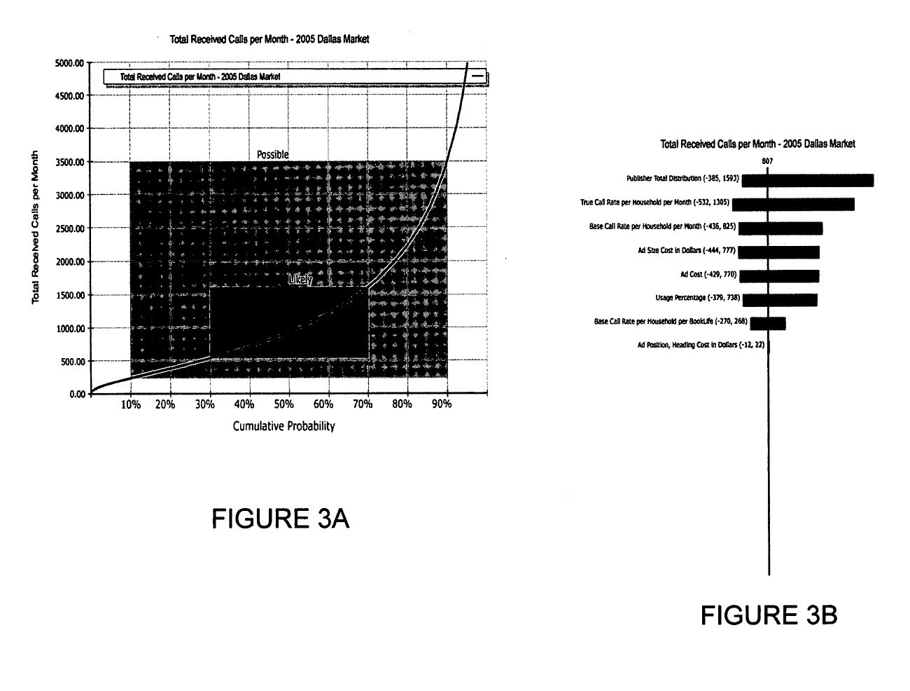

Turning now to FIGS. 3A and 3B, illustrated are two possible outputs from a DA module constructed in accordance with the principles of the present invention. FIG. 3A is a cumulative distribution function (“CDF”) and the predictive analytical results are embodied therein. A CDF is a curve depicting that a given probability on the X-axis will be satisfied by a value less than or equal to the corresponding value on the Y-axis. With this information, business decisions can be made as to the likelihood of an output occurring within certain bounds. FIG. 3B is a graphical representation illustrating the impact that various elements have on the predictive analytical results under consideration with those elements having the greatest impact on the top. In this manner, those elements that have the greatest impact on the output are easily identified along with the magnitude of their impact.

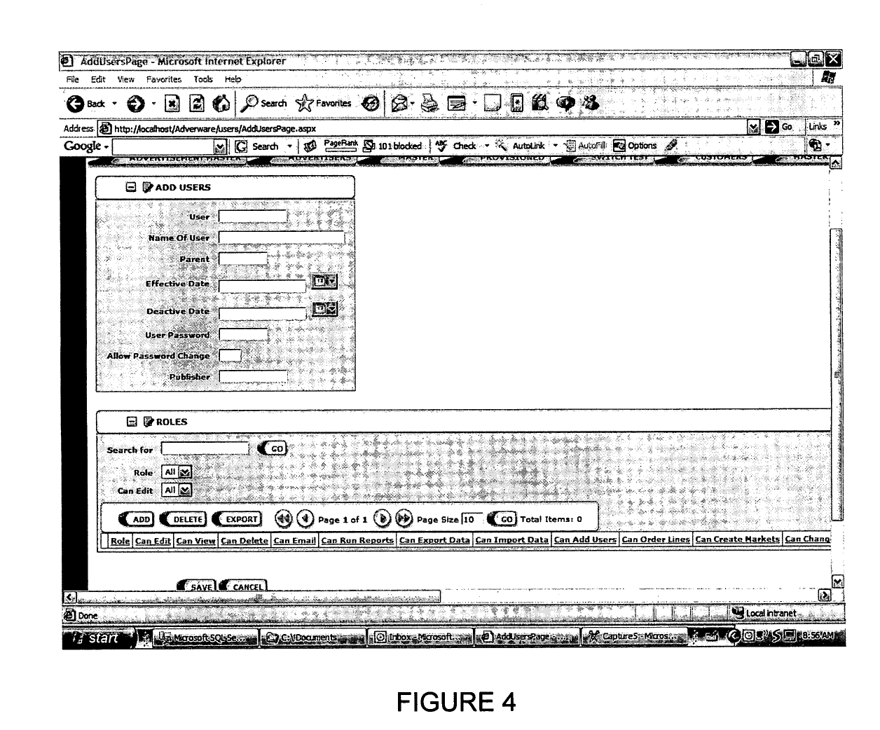

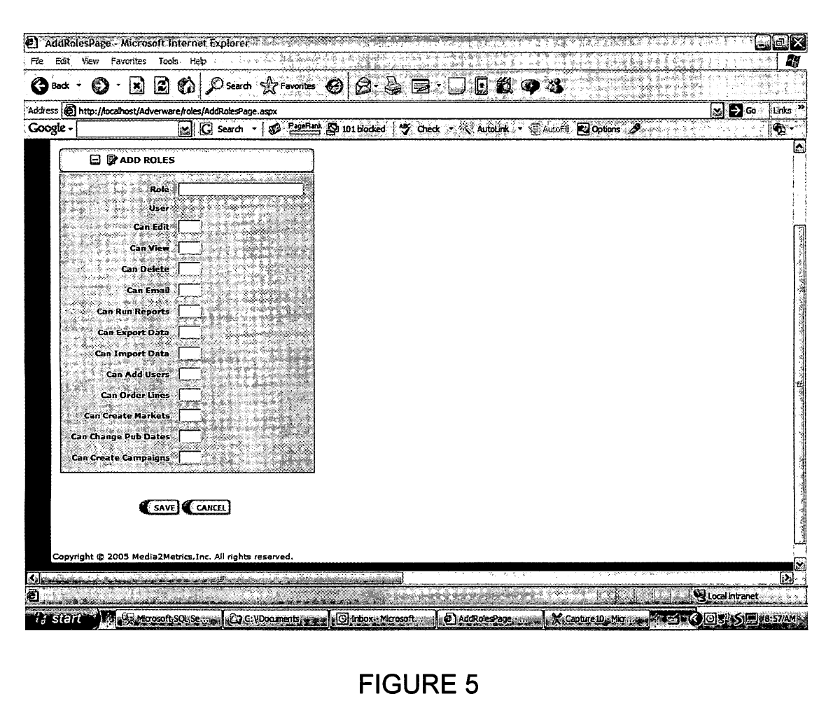

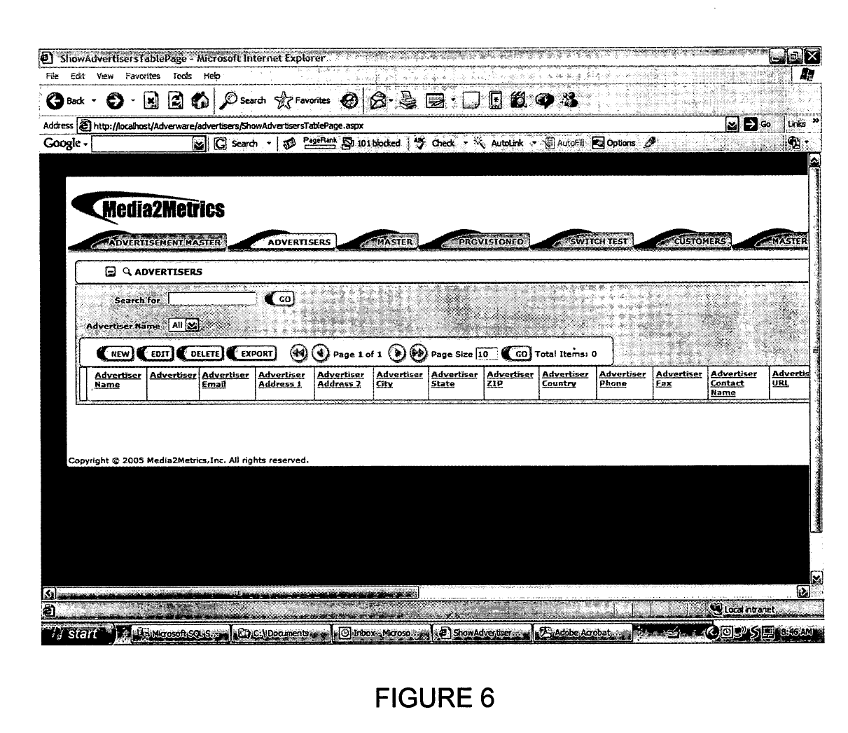

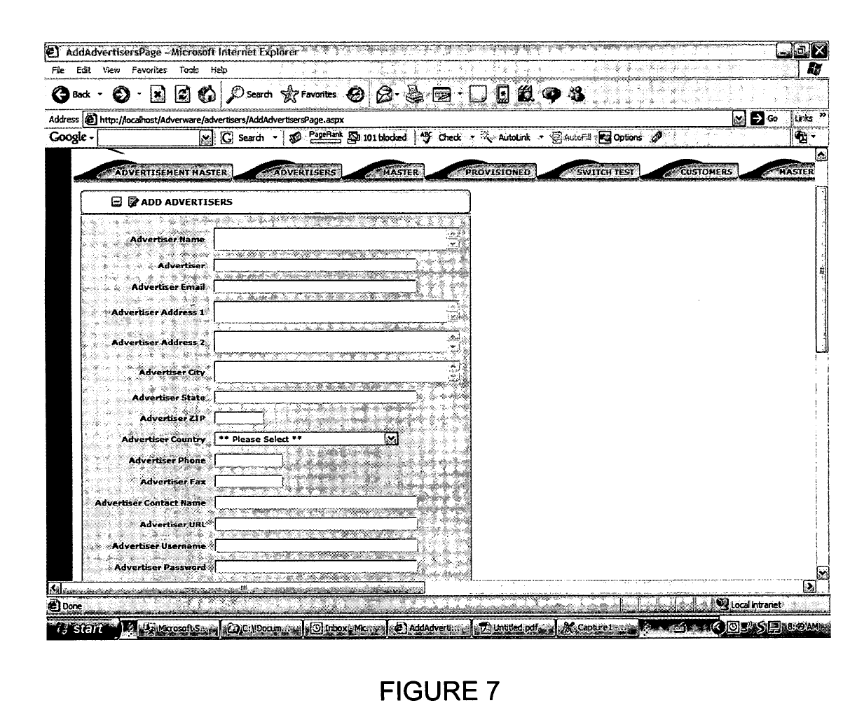

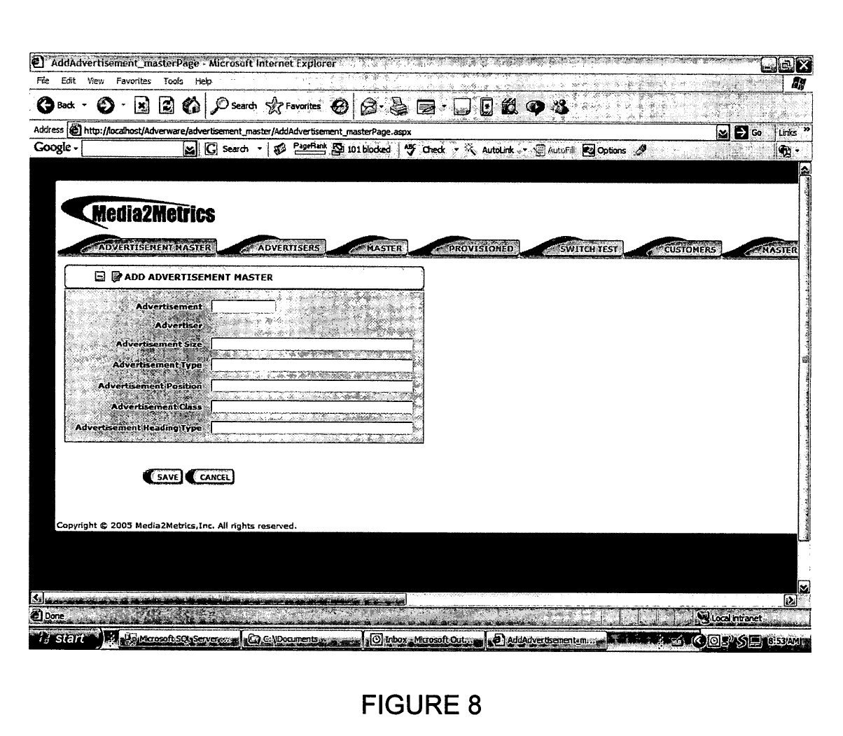

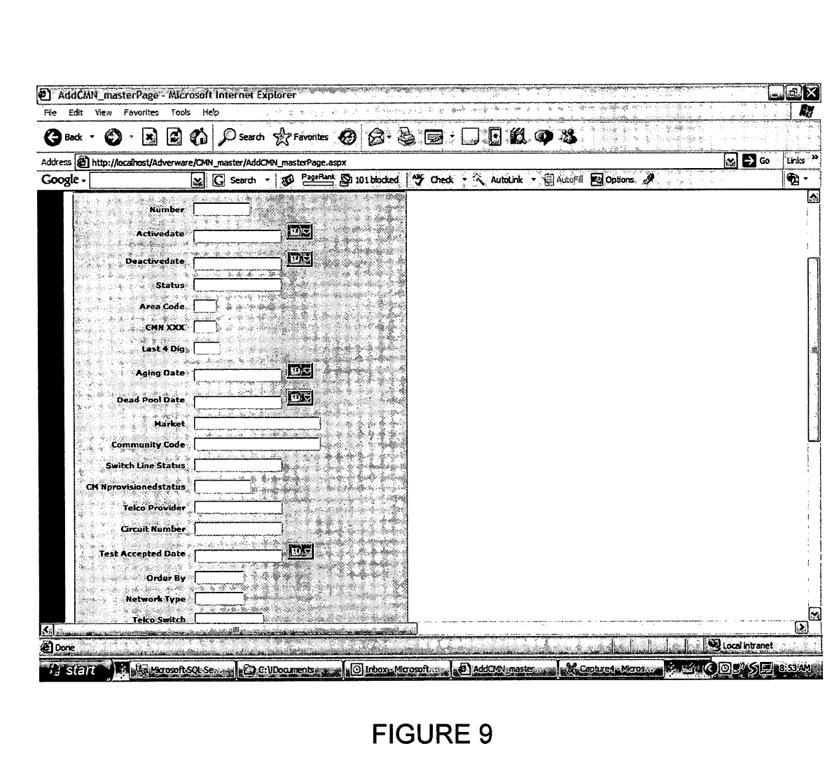

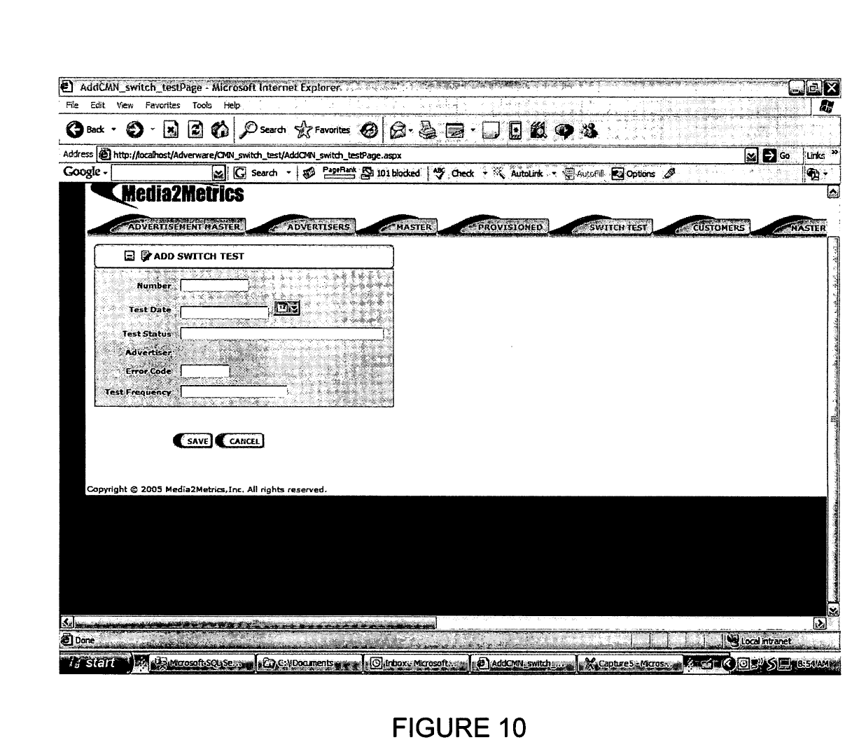

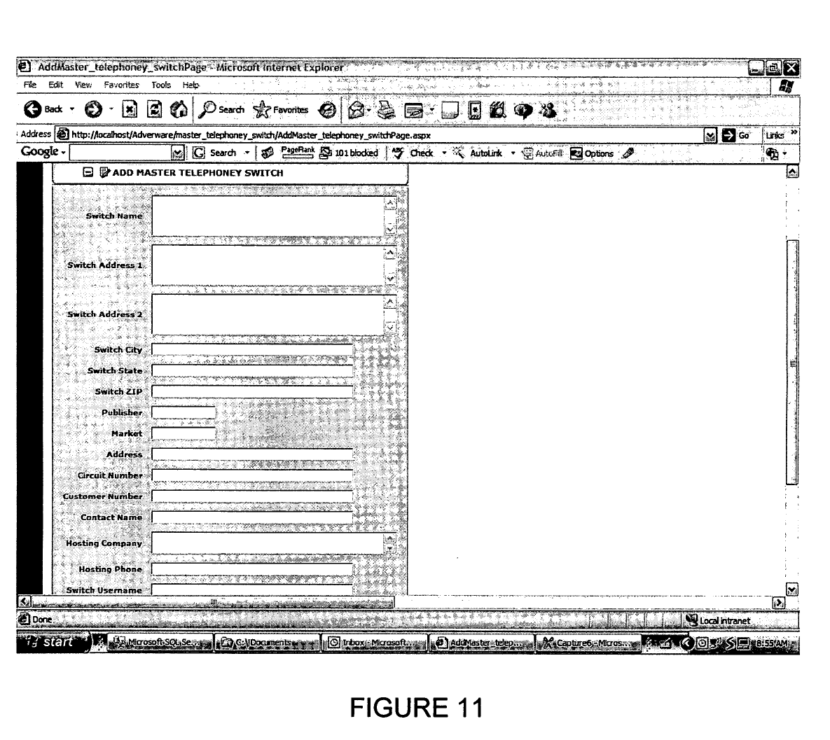

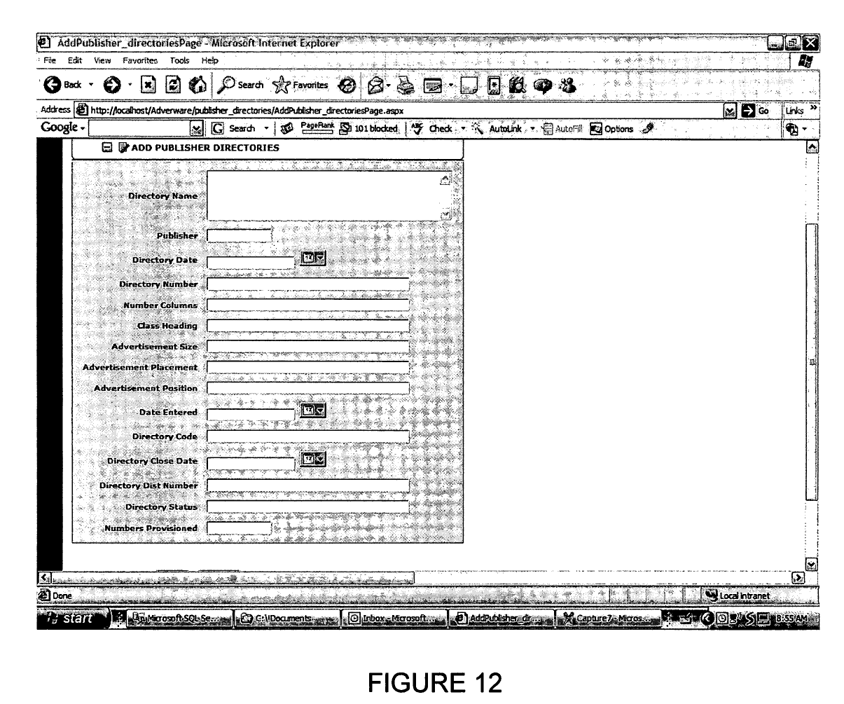

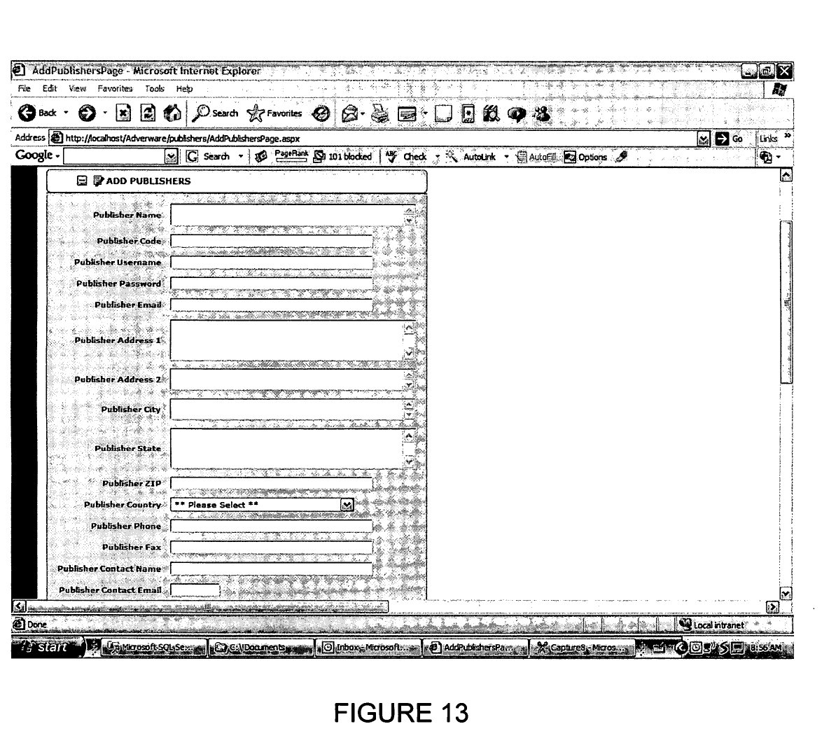

Turning now to FIGS. 4-13, illustrated are pictorial diagrams of embodiments of Web based outputs constructed in accordance with the principles of the present invention. They are meant for illustration purposes only to show the flexibility of the system and how it can be tailored for specific applications. It should be appreciated by those skilled in the art that the conception and specific embodiment disclosed in these screens may be readily utilized as a basis for modifying or designing other structures or processes for carrying out the same purposes of the present invention. It should also be appreciated by those skilled in the art that this invention comprehends input and output beyond the scope of the simple embodiments illustrated here. Another exemplary embodiment specifically applied to real estate applications for the real estate market segment is further disclosed. Use of the analytic advertising system permits integrated business intelligence solutions for real estate agents by providing the following:
track lead data real-time via the online software available 24/7;
provide online call performance reports;
provide instant notification via email/instant messenger of missed, unanswered or busy calls;
author/customize online reports;
geographical mapping that displays prospects calling location;
provide direct response ROI tracking;
provide direct mail interface;
provide real estate consumer demographics;
export data utility, convert reports to Excel, Tiff, CSV, PDF or XML;
electronically deliver call reports by day, week, or month;
provide local numbers, that are call centric to a market;
provide virtual PBX functions to manage call traffic; and
provide voice marketing strategies including property information lines.

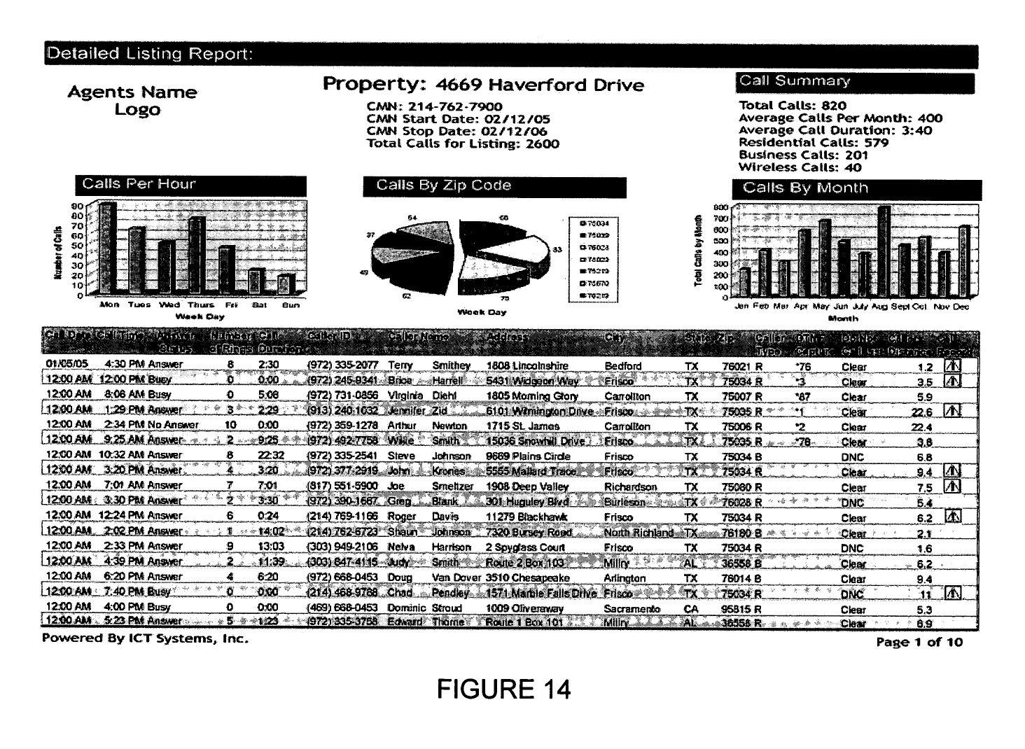

Turning now to FIG. 14, illustrated is a diagram of an exemplary call performance report constructed in accordance with the principles of the present invention. The call performance report can capture data such as:
date/time of prospects call origination;
how many rings before answered;
call duration—how long was the call;
originating number of the prospects call;
the name and address of the prospect;
call tracking number used in media;
advertising campaign start/stop;
total cumulative calls for the campaign;
total calls for the date range selected;
average calls for the month selected; and
breakdown of calls by residential, business, pay phone and wireless.

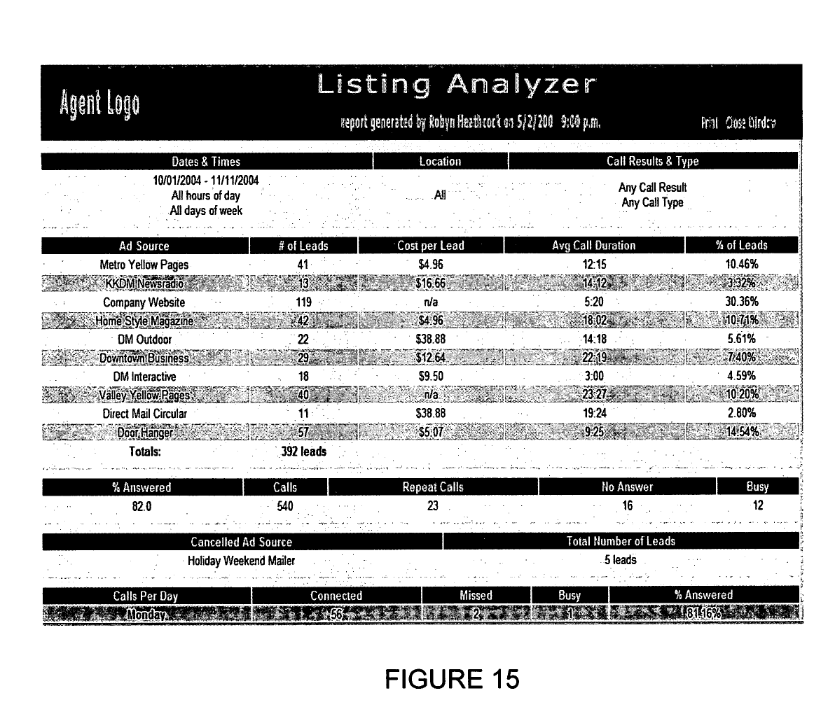

Turning now to FIG. 15, illustrated is a diagram of an exemplary listings metrics report constructed in accordance with the principles of the present invention. The listings metrics may include:
tracking calls by media;
determine cost per lead;
total calls to listing;
track repeat calls;
evaluate call status; and
provide listing analyzer report to the seller.

The system of the present invention provides a method, process, and system using both measured data related to advertising effectiveness of a specific customer, brand, or product set, and using meta-data from other sources to supplement the measured data. The system is capable of testing a plurality of hypotheses regarding the optimal placement of advertising, testing a plurality of hypotheses regarding the optimal expenditure for advertising and testing a plurality of hypotheses in a closed loop manner, with ongoing advertising data collection.

One skilled in the pertinent art should know that the principles of the present invention are not limited for use with the specific types of processes and modules described above. This invention can be readily realized in software, hardware, and a combination of both. It can be an independent application, or installed on a server(s) for multiple entries and multiple participants.

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof, to achieve the same unique results.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An analytic advertising system couplable to a Web-based data network, comprising:
a click2metrics module configured to receive advertising information from said Web-based data network and format said advertising information into an integrated flat file;
an intelligent query merge module configured to merge media advertising data with said integrated flat file into a data framework; and
a decision analysis module configured to generate predictive analytical results from said data framework.

2. The analytic advertising system as recited in claim 1 wherein said predictive analytical results are embodied in a cumulative distribution function.

3. The analytic advertising system as recited in claim 1 wherein said predictive analytical results are provided in real time customized Web-based reports.

4. The analytic advertising system as recited in claim 1 wherein said intelligent query merge module employs business intelligent framework standards to create said data framework.

5. The analytic advertising system as recited in claim 1 further comprising an analytical feedback module configured receive historical data and said predictive analytical results and provide corrective information to said decision analysis module.

6. The analytic advertising system as recited in claim 1 wherein said predictive analytical results include a return on investment associated with said advertising information and said media advertising data.

7. The analytic advertising system as recited in claim 1 wherein said analytic advertising system is employable in a real estate market segment.

8. The analytic advertising system as recited in claim 1 wherein said media adverting data is acquired from the group consisting of:
newspapers,
television,
satellite based video and data services, and
search engines.

9. The analytic advertising system as recited in claim 1 wherein said media advertising data is provided from data mining engines.

10. The analytic advertising system as recited in claim 1 wherein said media adverting data accepts metrics involved with people tracking, advertising metrics and referred advertisements.

11. A method of operating an analytic advertising system couplable to a Web-based data network, comprising:
receiving advertising information from said Web-based data network;
formatting said advertising information into an integrated flat file;
merging media advertising data with said integrated flat file into a data framework; and
generating predictive analytical results from said data framework.

12. The method as recited in claim 11 wherein said predictive analytical results are embodied in a cumulative distribution function.

13. The method as recited in claim 11 wherein said predictive analytical results are provided in real time customized Web-based reports.

14. The method as recited in claim 11 wherein said merging employs business intelligent framework standards to create said data framework.

15. The method as recited in claim 11 further comprising providing corrective information in accordance with generating said predictive analytical results based on historical data.

16. The method as recited in claim 11 wherein said predictive analytical results include a return on investment associated with said advertising information and said media advertising data.

17. The method as recited in claim 11 wherein said analytic advertising system is employable in a real estate market segment.

18. The method as recited in claim 11 wherein said media adverting data is acquired from the group consisting of:
newspapers,
television,
satellite based video and data services, and
search engines.

19. The method as recited in claim 11 wherein said media advertising data is provided from data mining engines.

20. The method as recited in claim 11 wherein said media adverting data accepts metrics involved with people tracking, advertising metrics and referred advertisements.
